(19) United States
(12) Patent Application Publication
(10) Pub. No.: US 2025/0165154 A1
(43) Pub. Date: May 22, 2025

(54) STORAGE DEVICE BASED ON FLASH MEMORY AND METHOD FOR MANAGING SUPER BLOCK THEREOF

(71) Applicant: Samsung Electronics Co., Ltd., Suwon-si (KR)

(72) Inventors: Seungho SONG, Suwon-si (KR); Taehyung KWON, Suwon-si (KR); Jeong-Eun KIM, Suwon-si (KR); Jeongseop SIM, Suwon-si (KR); Jungho YUN, Suwon-si (KR); Seunghwan HA, Suwon-si (KR)

(73) Assignee: Samsung Electronics Co., Ltd., Suwon-si (KR)

(21) Appl. No.: 18/750,234

(22) Filed: Jun. 21, 2024

(30) Foreign Application Priority Data
Nov. 22, 2023 (KR) 10-2023-0163251

(51) Int. Cl. G06F 3/06

(52) U.S. Cl. CPC G06F 3/0616; G06F 3/064; G06F 3/0679

(57) ABSTRACT

A storage device includes: a memory device including a plurality of memory blocks; and a memory controller configured to match the plurality of memory blocks to a plurality of super blocks in numbers of memory blocks. The memory controller further configured to select at least one memory block from each of super blocks that contain no bad blocks among the plurality of super blocks, release the matching of the at least one selected memory block from each of the super blocks that contain no bad blocks, and generate at least one additional super block based on the at least one selected memory block.

### CROSS-REFERENCE TO RELATED APPLICATIONS

This application claims priority under 35 U.S.C. § 119 to Korean Patent Application No. 10-2023-0163251 filed on Nov. 22, 2023, in the Korean Intellectual Property Office, the disclosures of which is incorporated by reference herein in their entireties.

### BACKGROUND

Example embodiments of the present inventive concepts described herein relate to a storage device including a semiconductor memory device, and more particularly, relate to a storage device based on flash memory and a super block management method thereof.

A semiconductor memory may be mainly classified as a volatile memory or a non-volatile memory. Read and write speeds of the volatile memory (for example, a DRAM (Dynamic Random Access Memory) or an SRAM (Static Random Access Memory)) are fast, but the data stored in the volatile memory disappears when a power is turned off. In contrast, the non-volatile memory may retain data even when the power is turned off. Therefore, the non-volatile memory may be used to store contents that must be, or are advantageous to be, preserved regardless of whether power is supplied or not.

A representative example of a non-volatile memory is a flash memory. The flash memory is widely used as a storage medium for audio and video data in information devices such as computers and smartphones. Recently, high-capacity, high-speed input/output and low-power technologies for the flash memory are being actively researched for installation in mobile devices such as the smartphone.

A storage device using flash memory may include memory blocks. In order to use the memory blocks efficiently, the storage device may divide the memory blocks into super blocks and manage the super blocks.

### SUMMARY

Example embodiments of the present inventive concepts provide a storage device configured to rearrange memory blocks included in each of a plurality of super blocks to reduce capacity of super blocks storing meta data and increase the number of super blocks storing user data.

According to some example embodiments, a storage device, comprising: a memory device including a plurality of memory blocks; and a memory controller configured to match the plurality of memory blocks to a plurality of super blocks in numbers of memory blocks. The memory controller further configured to select at least one memory block from each of super blocks that contain no bad blocks among the plurality of super blocks, release the matching of the at least one selected memory block from each of the super blocks that contain no bad blocks, and generate at least one additional super block based on the at least one selected memory block.

According to some example embodiments, a storage device, comprising: a memory device including a plurality of memory dies; and a memory controller configured to match at least one memory block included in each of the plurality of memory dies to each of a plurality of super blocks. The memory controller further configured to store meta data in first super blocks among the plurality of super blocks, store user data in second super blocks among the plurality of super blocks, select first memory blocks from each of the first super blocks, release matching of the first memory blocks from each of the first super blocks, select second memory blocks from each of the second super blocks, release matching of the second memory blocks from each of the second super blocks, and generate at least one additional super block based on the first memory blocks and the second memory blocks.

According to some example embodiments, a super block managing method of a storage device including a plurality of memory blocks, the method comprising: setting a plurality of super blocks by matching a plurality of memory blocks in numbers of memory blocks; selecting at least one memory block from each of the plurality of super blocks; and generating at least one additional super block based on the selected memory blocks.

### BRIEF DESCRIPTION OF THE DRAWINGS

The above and other objects and features of the present inventive concepts will become apparent by describing in detail some example embodiments thereof with reference to the accompanying drawings.

FIG. 1 is a block diagram illustrating a user device according to some example embodiments.

FIG. 2 is a block diagram illustrating an example of the memory device illustrated in FIG. 1 according to some example embodiments.

FIG. 3 is a circuit diagram illustrating an example of a memory block BLK1 of the memory cell array illustrated in FIG. 2 according to some example embodiments.

FIG. 4 is a circuit diagram illustrating cell strings selected by the first string selection line SSL1 among the cell strings of the memory block BLK1 illustrated in FIG. 3 according to some example embodiments.

FIG. 5 is a block diagram illustrating the memory controller of FIG. 1 according to some example embodiments.

FIG. 6 is a diagram illustrating an example of matching a plurality of memory blocks included in the memory cell array of FIG. 2 with a plurality of super blocks according to some example embodiments.

FIG. 7 is a diagram illustrating an example of a method for managing the super blocks of FIG. 6 according to some example embodiments.

FIG. 8 is a flowchart illustrating the super block management method of FIG. 7 according to some example embodiments.

FIG. 9 is a diagram illustrating another example of a method for managing the super blocks of FIG. 6 according to some example embodiments.

FIG. 10 is a flowchart illustrating the super block management method of FIG. 9 according to some example embodiments.

FIG. 11 is a diagram illustrating another example of a method for managing the super blocks of FIG. 6 according to some example embodiments.

FIG. 12 is a flowchart illustrating the super block management method of FIG. 11 according to some example embodiments.

FIG. 13 is a diagram illustrating another example of the memory device of FIG. 1 according to some example embodiments.

FIG. 14 is a diagram illustrating a plurality of super blocks set in the memory device of FIG. 13 according to some example embodiments.

FIG. 15 is a diagram illustrating an example of a method for managing the super blocks of FIG. 14 according to some example embodiments.

FIG. 16 is a flowchart illustrating the super block management method of FIG. 15 according to some example embodiments.

FIG. 17 is a diagram illustrating a plurality of super blocks set in the memory device of FIG. 13 according to some example embodiments.

FIG. 18 is a diagram illustrating an example of a method for managing the super blocks of FIG. 17 according to some example embodiments.

FIG. 19 is a diagram illustrating a plurality of super blocks set in the memory device of FIG. 13 according to some example embodiments.

FIG. 20 is a diagram illustrating an example of a method for managing the super blocks of FIG. 19 according to some example embodiments.

FIG. 21 is a flowchart illustrating the super block management method of FIGS. 17 to 20 according to some example embodiments.

### DETAILED DESCRIPTION

Below, some example embodiments of the present inventive concepts will be described more fully with reference to the accompanying drawings, in which some example embodiments of the inventive concepts are shown. As those skilled in the art would realize, the described example embodiments may be modified in various different ways, all without departing from the spirit and scope of the present inventive concepts.

Accordingly, the drawings and description are to be regarded as illustrative in nature and not restrictive. Like reference numerals designate like elements throughout the specification. The sequence of operations or steps are not limited to the order presented in the claims or figures unless specifically indicated otherwise. The order of operations or steps may be changed, several operations or steps may be merged, a certain operation or step may be divided, and a specific operation or step may not be performed.

As used herein, the singular forms “a” and “an” are intended to include the plural forms as well, unless the context clearly indicates otherwise. Although the terms first, second, and the like may be used herein to describe various elements, components, steps and/or operations, these terms are only used to distinguish one element, component, step or operation from another element, component, step, or operation.

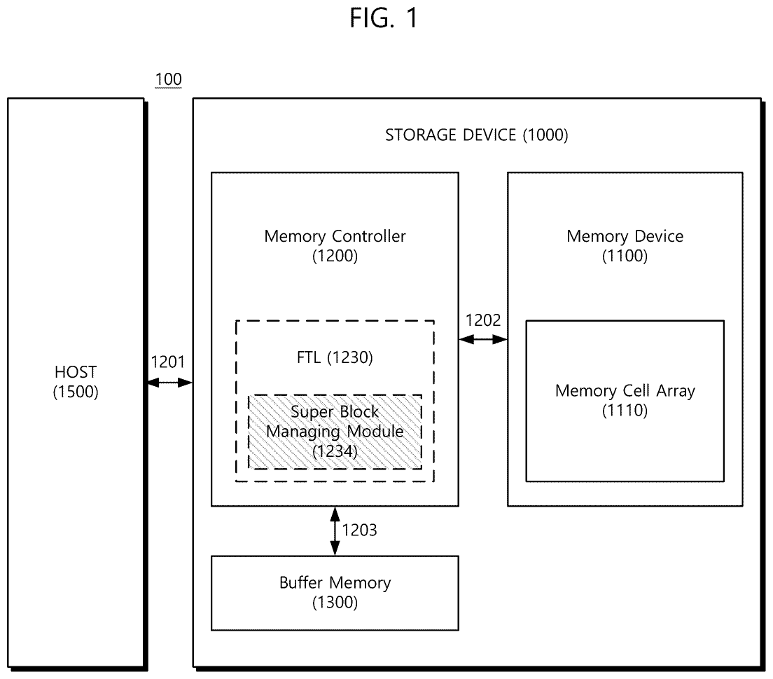

FIG. 1 is a block diagram illustrating a user device according to some example embodiments. Referring to FIG. 1, the user device 100 may include a storage device 1000 and a host 1500. The storage device 1000 and the host 1500 may be connected through a host interface 1201. The host interface 1201 may be a standard interface such as ATA, SATA, PATA, USB, SCSI, ESDI, IEEE 1394, IDE, and/or card interface, etc., but example embodiments are not limited thereto.

According to some example embodiments, the storage device 1000 may be a storage device based on a non-volatile memory. For example, the storage device 1000 may include a memory device 1100, a memory controller 1200, and a buffer memory 1300. The memory device 1100 may be a non-volatile memory such as a flash memory or phase change memory (PRAM). When the memory device 1100 is a flash memory, the storage device 1000 may be a flash storage device based on the flash memory. For example, the storage device 1000 may be an SSD, UFS, and/or memory card, etc. The buffer memory 1300 may include volatile memory (for example, DRAM).

According to some example embodiments, the memory device 1100 may be connected to the memory controller 1200 through a memory interface 1202. The memory device 1100 may include a memory cell array 1110 and a peripheral circuit (not shown). The peripheral circuitry may include all analog or digital circuits required to store or read data in the memory cell array 1110.

According to some example embodiments, the peripheral circuit may receive external power from the memory controller 1200 and generate various levels of internal power. The peripheral circuit may receive commands, addresses, and data from the memory controller 1200, and store the data in the memory cell array 1110 according to the control signals. In some example embodiments, the peripheral circuit may read data stored in the memory cell array 1110 and provide the data to the memory controller 1200.

According to some example embodiments, the memory cell array 1110 may include a plurality of memory blocks. Each memory block may have a vertical three-dimensional (3D) structure. Each memory block may include a plurality of memory cells. Multi-bit data may be stored in each memory cell. For example, the memory device 1100 may be a TLC (Triple-level cell) flash memory capable of storing 3 bits of data in one memory cell.

According to some example embodiments, the memory cell array 1110 may be located next to or above the peripheral circuit due to, for example, the design arrangement structure. The structure in which the memory cell array 1110 is located above the peripheral circuit is called a COP (cell on peripheral) structure. The memory cell array 1110 may be manufactured as a separate chip from the peripheral circuit. The upper chip including the memory cell array 1110 and the lower chip including the peripheral circuit may be connected to each other using a bonding method. This structure is called C2C (chip-to-chip) structure.

According to some example embodiments, the memory controller 1200 may be connected between the memory device 1100 and the host 1500. In some example embodiments, the memory controller 1200 may be connected between the buffer memory 1300 and the host 1500. The memory controller 1200 may control read or write operations of the memory device 1100 and/or the buffer memory 1300 in response to a request from the host 1500. The memory controller 1200 may receive host data from the host 1500 and provide, transmit, or send it to the memory device 1100 and/or the buffer memory 1300.

According to some example embodiments, the memory controller 1200 may include a control unit and a work memory (not shown). The control unit may control overall operations of the memory controller 1200. For example, the control unit may control a flash translation layer (FTL) 1230 to perform an address mapping operation. The control unit may be a commercially available or custom microprocessor.

According to some example embodiments, the work memory may be cache memory (for example, a SRAM). The work memory may serve as a buffer memory that temporarily stores data. In some example embodiments, the work memory may be a driving memory of the memory controller 1200. The work memory may drive the FTL 1230.

According to some example embodiments, the FTL 1230 may be firmware or a program for efficiently managing the memory device 1100. The memory device 1100 may not support an overwrite function different from a hard disk drive. Therefore, the memory device 1100 may perform, or be configured to perform, the following example process while updating data written to the page. First, the memory device 1100 may copy all valid data in the first memory block to which the written page belongs to an empty second memory block. Second, the memory device 1100 may erase the first memory block and make it an empty memory block (e.g., such that the first memory block is an empty memory block). The memory device 1100 may perform a large number of page copy operations (for example, a page read operation and/or a page write operation) and erase operations while going through this process.

According to some example embodiments, the FTL 1230 may be used between the host 1500 and the memory device 1100 to reduce the number of page copy and erase operations. The FTL 1230 may perform an address mapping function, a garbage collection function, and a wear-leveling function, etc. When an overwrite request is received from the host 1500, the address mapping function may write the corresponding data to another empty page instead of overwriting the original page, thereby reducing additional page copy and block erase operations. For this purpose, an address mapping table having a specified size must be maintained in the work memory and the buffer memory 1300. Through this, the FTL 1230 may manage an operation of mapping a logical address received from the host 1500 to a physical address in the memory device 1100.

According to some example embodiments, the FTL 1230 may include a super block managing module 1234. The super block managing module 1234 may manage a plurality of memory blocks included in the memory cell array 1110 of the memory device 1100 as a plurality of super blocks. The super block managing module 1234 may match the plurality of memory blocks to each of the plurality of super blocks. The super block managing module 1234 may manage an address mapping table corresponding to the plurality of super blocks.

According to some example embodiments, the buffer memory 1300 may be connected to the memory controller 1200 through a buffer interface 1203. For example, the buffer memory 1300 may be used to temporarily store data to be stored in or read from the memory device 1100. In some example embodiments, a cache area capable of storing cache data may be allocated to the buffer memory 1300. The buffer memory 1300 may be implemented with a DRAM and a SRAM, etc. The buffer memory 1300 may be included in the memory device 1100 or the memory controller 1200.

According to some example embodiments, the host 1500 may include a processor and a host memory (not shown). The processor and the host memory may be connected via an address/data bus. The host 1500 may be a personal digital assistance (PDA), a computer, a digital audio player, a digital camera, and/or a mobile phone, etc. The host memory may be a non-volatile or volatile memory in the form of a cache, a ROM, a PROM, an EPROM, an EEPROM, a flash, a SRAM, a DRAM, or the like.

According to some example embodiments, the host memory may drive a plurality of software or firmware. For example, the host memory may drive an operating system (OS), applications, a file system, a memory manager, and I/O drivers, etc.

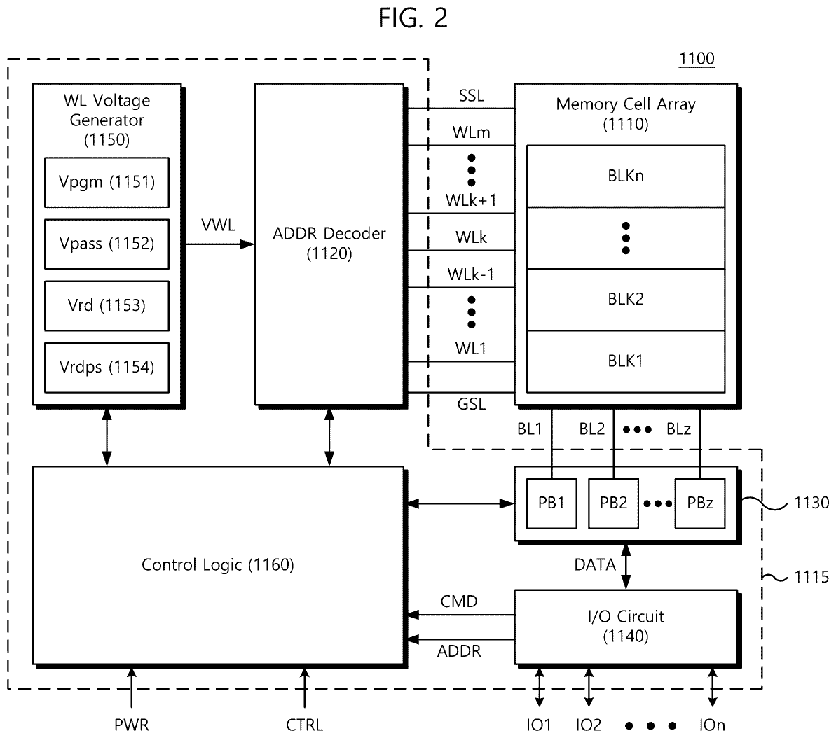

FIG. 2 is a block diagram illustrating an example of the memory device illustrated in FIG. 1 according to some example embodiments. The storage device 1000 of FIG. 1 may be a flash storage device based on flash memory. For example, the storage device 1000 may be implemented as an SSD, UFS, and/or memory card, etc.

Referring to FIGS. 1 and 2, the memory device 1100 may include a memory cell array 1110 and a peripheral circuit 1115. The peripheral circuit 1115 may include an address decoder 1120, a page buffer circuit 1130, an input/output circuit 1140, a word line voltage generator 1150, and control logic 1160.

According to some example embodiments, the memory cell array 1110 may include a plurality of memory blocks BLK1 to BLKn. Each memory block may be configured as a plurality of pages. Each page may include a plurality of memory cells. Each memory cell may store multi-bit data (for example, two or more bits). Each memory block may correspond to an erase unit, and each page may correspond to a read and/or write unit.

According to some example embodiments, the memory cell array 1110 may be formed in a direction perpendicular to a substrate. A gate electrode layer and an insulation layer may be alternately deposited on the substrate. Each memory block (for example, BLK1) may be connected to one or more string selection lines SSL, a plurality of word lines WL1 to WLm, and one or more ground selection lines GSL. WLk is a selected word line sWL and the remaining word lines (WL1 to WLk−1, WLk+1 to WLm) are unselected word lines uWL.

According to some example embodiments, the address decoder 1120 may be connected to the memory cell array 1110 through selection lines SSL and GSL and word lines WL1 to WLm. The address decoder 1120 may select a word line during a program or read operation. The address decoder 1120 may receive the word line voltage VWL from the word line voltage generator 1150 and provide, transmit, or send a program voltage or read voltage to the selected word line sWL.

According to some example embodiments, the page buffer circuit 1130 may be connected to the memory cell array 1110 through bit lines BL1 to BLz. The page buffer circuit 1130 may temporarily store data to be stored in the memory cell array 1110 or data read from the memory cell array 1110. The page buffer circuit 1130 may include page buffers PB1 to PBz connected to respective bit lines. Each page buffer may include a plurality of latches to store or read multi-bit data.

According to some example embodiments, the input/output circuit 1140 may be internally connected to the page buffer circuit 1130 through data lines DATA and externally connected to the memory controller (e.g., refer to FIG. 1, 1200) through the input/output lines IO1 to IOn. The input/output circuit 1140 may receive program data from the memory controller 1200 during a program operation. In some example embodiments, the input/output circuit 1140 may provide, transmit, or send data read from the memory cell array 1110 to the memory controller 1200 during a read operation.

According to some example embodiments, the word line voltage generator 1150 may receive internal power from the control logic 1160 and generate a word line voltage VWL required to read or write data. The word line voltage VWL may be provided to a selected word line sWL or unselected word lines uWL through the address decoder 1120.

According to some example embodiments, the word line voltage generator 1150 may include a program voltage generator 1151 and a pass voltage generator 1152. The program voltage generator 1151 may generate a program voltage Vpgm provided to the selected word line sWL during a program operation. The pass voltage generator 1152 may generate a pass voltage Vpass provided to the selected word line sWL and the unselected word lines uWL.

According to some example embodiments, the word line voltage generator 1150 may include a read voltage generator 1153 and a read pass voltage generator 1154. The read voltage generator 1153 may generate a select read voltage Vrd provided to the select word line sWL during a read operation. The read pass voltage generator 1154 may generate a read pass voltage Vrdps provided to unselected word lines uWL. The read pass voltage Vrdps may be a voltage sufficient to turn on memory cells connected to the unselected word lines uWL during a read operation.

According to some example embodiments, the control logic 1160 may control operations such as read, write, and erase of the memory device 1100 using commands CMD, addresses ADDR, and control signals CTRL provided from the memory controller 1200. The addresses ADDR may include a block selection address for selecting one memory block, a row address for selecting one page, and a column address for selecting one memory cell.

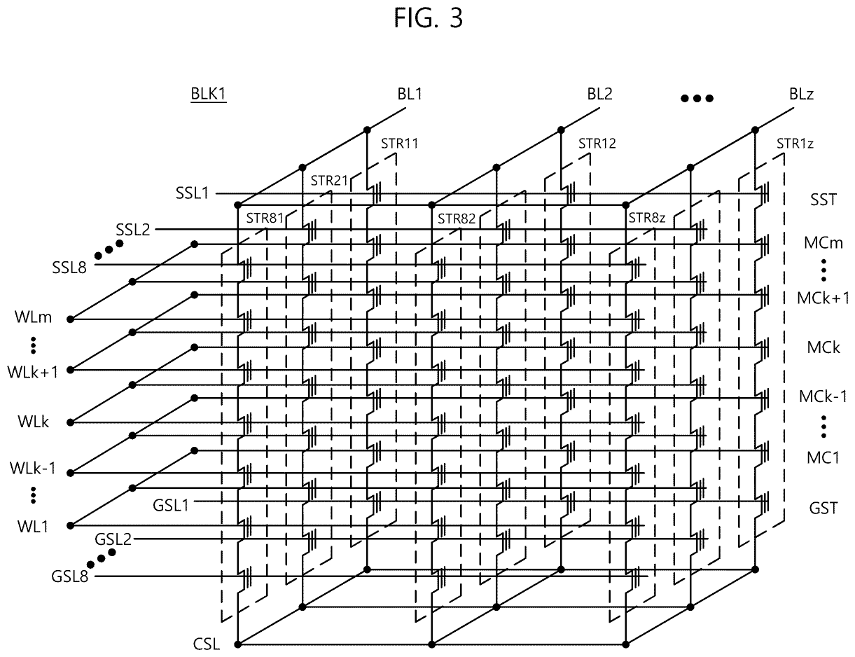

FIG. 3 is a circuit diagram illustrating an example of a memory block BLK1 of the memory cell array illustrated in FIG. 2 according to some example embodiments. Referring to FIG. 3, in the memory block BLK1, a plurality of cell strings STR11 to STR8z may be formed between the bit lines BL1 to BLz and a common source line CSL. Each cell string includes a string selection transistor SST, a plurality of memory cells MC1 to MCm, and a ground selection transistor GST.

According to some example embodiments, the string selection transistors SST may be connected with string selection lines SSL1 to SSL8. The ground selection transistors GST may be connected with ground selection lines GSL1 to GSL8. The string selection transistors SST may be connected with the bit lines BL1 to BLz, and the ground selection transistors GST may be connected with the common source line CSL.

According to some example embodiments, the first to m-th word lines WL1 to WLm may be connected with the plurality of memory cells MC1 to MCm in a row direction. The first to z-th bit lines BL1 to BLz may be connected with the plurality of memory cells MC1 to MCm in a column direction.

According to some example embodiments, the first word line WL1 may be placed above the first to eighth ground selection lines GSL1 to GSL8. The first memory cells MC1 that are placed at the same height from the substrate may be connected with the first word line WL1. In a similar manner, the second to m-th memory cells MC2 to MCm that are placed at the same heights from the substrate may be respectively connected with the second to m-th word lines WL2 to WLm.

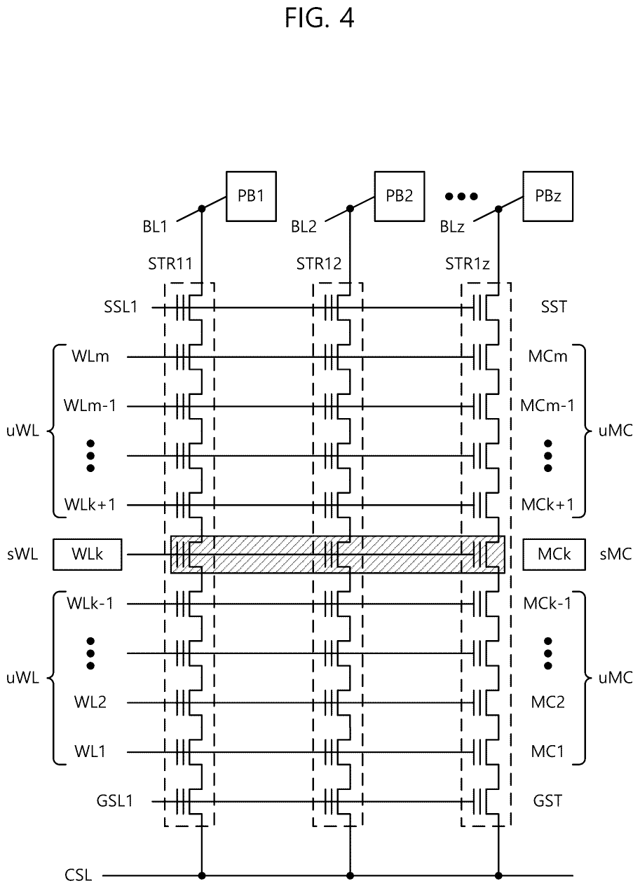

FIG. 4 is a circuit diagram illustrating cell strings selected by the first string selection line SSL1 among the cell strings of the memory block BLK1 illustrated in FIG. 3 according to some example embodiments. The 11th to 1z cell strings (STR11 to STR1z) may be selected by the first string selection line (SSL1). The 11th to 1z cell strings STR11 to STR1z may be connected to the 1st to zth bit lines BL1 to BLz, respectively. First to zth page buffers PB1 to PBz may be connected to the first to zth bit lines BL1 to BLz, respectively.

According to some example embodiments, the 11th cell string (STR11) may be connected to the first bit line (BL1) and the common source line (CSL). The 11th cell string (STR11) includes string selection transistors (SST) selected by the first string selection line (SSL1) and first to mth memory cells (MC1 to MCm) connected to the first to mth word lines (WL1 to WLm) and ground selection transistors (GST) selected by the first ground selection line (GSL1). The twelfth cell string STR12 may be connected to the second bit line BL2 and the common source line CSL. The 1z cell string (STR1z) may be connected to the zth bit line (BLz) and the common source line (CSL).

According to some example embodiments, the first word line (WL1) and the m-th word line (WLm) may be edge word lines (edge WL). The second word line (WL2) and the m−1 word line (WLm−1) may be edge adjacent word lines (edge adjacent WL). The kth word line (WLk) may be a selection word line (sWL). The k−1th word line (WLk−1) and the k+1th word line (WLk+1) may be adjacent word lines (adjacent WL) located next to the selected word line. If the kth word line (WLk) is a selected word line (sWL), the remaining word lines (WL1 to WLk−1, WLk+1 to WLm) may be unselected word lines (uWL; unselected WL).

According to some example embodiments, the first memory cells MC1 and the mth memory cells MCm may be edge memory cells (edge MC). The second memory cells MC2 and the m−1th memory cells MCm−1 may be edge adjacent memory cells (edge adjacent MC). The kth memory cells (MCk) may be selection memory cells (sMC). The k−1th memory cells MCk−1 and the k+1th memory cells MCk+1 may be memory cells adjacent to the selected memory cells (hereinafter referred to as adjacent memory cells (adjacent MC)). If the kth memory cells (MCk) are selected memory cells (sMC), the remaining memory cells (MC1 to MCk−1, MCk+1 to MCm) may be unselected memory cells (uMC; unselected MC).

According to some example embodiments, a set of memory cells selected by one string selection line and connected to one word line may be one page. For example, memory cells selected by the first string selection line (SSL1) and connected to the kth word line (WLk) may constitute one page. For example, eight pages may be configured in the k-th word line (WLk). Among the eight pages, the page connected to the first string selection line (SSL1) is a selected page, and the pages connected to the second to eighth string selection lines (SSL2 to SSL8) are unselected pages.

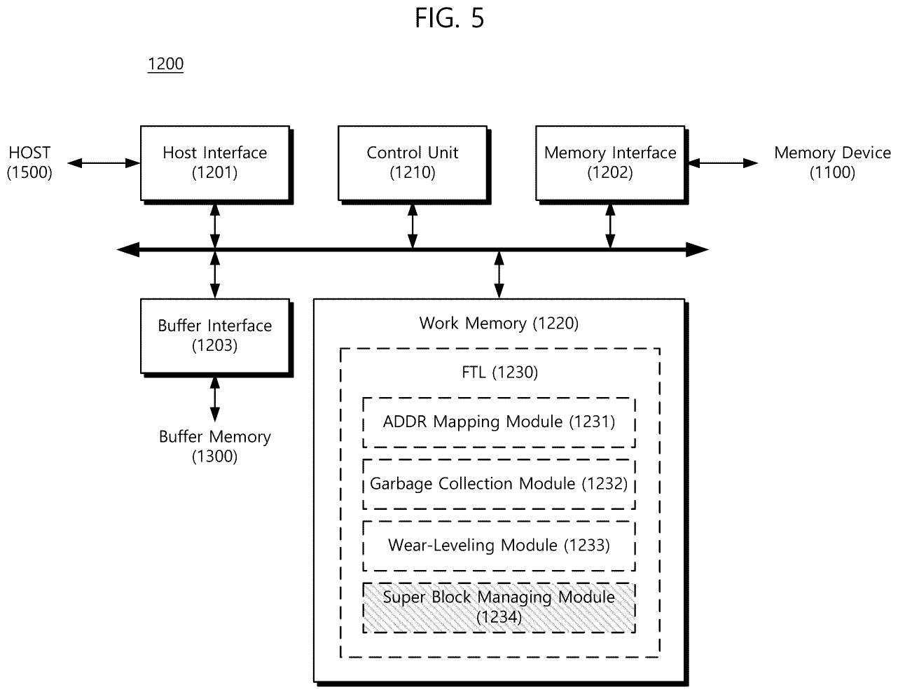

FIG. 5 is a block diagram illustrating the memory controller of FIG. 1 according to some example embodiments. Referring to FIG. 5, the memory controller 1200 may include a host interface 1201, a memory interface 1202, a buffer interface 1203, a control unit 1210, and a work memory 1220.

Although not illustrated in FIG. 5, in some example embodiments, the memory controller 1200 may further include various other components. For example, the memory controller 1200 may further include an ECC (error correction code) circuit, a command generation module, or the like, but example embodiments are not limited thereto. The ECC circuit may generate an error correction code (ECC) to correct fail bits or error bits of data received from the memory device 1100. The command generation module may generate a command CMD for controlling memory operations according to a request from the host 1500.

According to some example embodiments, the host interface 1201 may provide an interface between the host 1500 and the memory controller 1200. Standard interfaces include various interface methods such as an advanced technology attachment (ATA), a serial ATA (SATA), an external SATA (e-SATA), a small computer small interface (SCSI), a serial attached SCSI (SAS), a peripheral component interconnection (PCI), a PCI express (PCI-E), an IEEE 1394, an universal serial bus (USB), a secure digital (SD) card, a multi media card (MMC), an embedded multi media card (eMMC), universal flash storage (UFS), a compact flash (CF) card interface, or the like.

According to some example embodiments, the memory interface 1202 may provide an interface between the memory device 1100 and the memory controller 1200. For example, write or read data may be transmitted to, or sent to, and received from the memory device 1100 through the memory interface 1202. The memory interface 1202 may provide commands and addresses to the memory device 1100. In some example embodiments, the memory interface 1202 may provide, transmit, or send data read from the memory device 1100 to the memory controller 1200.

According to some example embodiments, the buffer interface 1203 may provide an interface between the buffer memory 1300 and the memory controller 1200. For example, data temporarily stored in the buffer memory 1300 may be transmitted/sent to and received from the buffer memory 1300 through the buffer interface 1203.

According to some example embodiments, the control unit 1210 may include a central processing unit (CPU), a microprocessor, or the like, and may control the overall operation of the memory controller 1200. The control unit 1210 may drive firmware loaded in the work memory 1220 to control the memory controller 1200.

According to some example embodiments, the work memory 1220 may be implemented with various memories, for example, at least one of a cache memory, a DRAM, a SRAM, a PRAM, and a flash memory. The work memory 1220 may drive a flash transition layer (FTL) 1230 under the control of the control unit 1210.

According to some example embodiments, the FTL 1230 may be firmware or a program for efficiently managing the memory device 1100. Unlike a hard disk, the memory device 1100 does not support an overwrite function. Therefore, to modify data written on a page, it is necessary to copy all valid data (or valid pages) in a previous block to which the page belongs to another empty block and delete the previous block. This process may perform multiple page copy (read and write pages) and erase operations.

According to some example embodiments, the FTL 1230 is used between the host 1500 and the memory device 1100 to reduce the number of page copy and erase operations. The FTL 1230 may include an address mapping module 1231, a garbage collection module 1232, and a wear-leveling module 1233.

According to some example embodiments, the address mapping module 1231 may perform an address mapping operation on a page-by-page or block-by-block basis. The page address mapping operation is an operation which converts a logical page address received from the file system into a physical page address within the memory device 1100. In some example embodiments, a page-level address mapping table may be maintained in the work memory 1220 for the page address mapping operation. The page address mapping operation may provide excellent, beneficial, or advantageous garbage collection performance but may require a large address mapping table.

According to some example embodiments, the garbage collection module 1232 may perform a garbage collection operation by referring to the address mapping table. For example, to secure one or more free blocks, the garbage collection module 1232 may use an address mapping table, record one or more valid data stored in a source block to a random block, and secure a free block by erasing the source block in which all the valid data have been moved.

According to some example embodiments, the wear-leveling module 1233 may manage wear-level of memory cells of the memory device 1100. Memory cells may be deteriorated by write and erase operations, etc. Deteriorated memory cells may cause defects. The wear-leveling module 1233 may manage program and erase cycles for the memory cell array 1110 to prevent specific cell areas from wearing out faster than other cell areas. The wear-leveling module 1233 may control the address mapping module 1231 such that program and erase times may be equally assigned to cell areas of the memory cell array 1110.

According to some example embodiments, the FTL 1230 may include a super block managing module 1234. For example, the super block managing module 1234 may manage a plurality of memory blocks included in the memory cell array 1110 as a plurality of super blocks. The super block managing module 1234 may match the plurality of memory blocks to each of the plurality of super blocks. The super block managing module 1234 may manage an address mapping table corresponding to the plurality of super blocks.

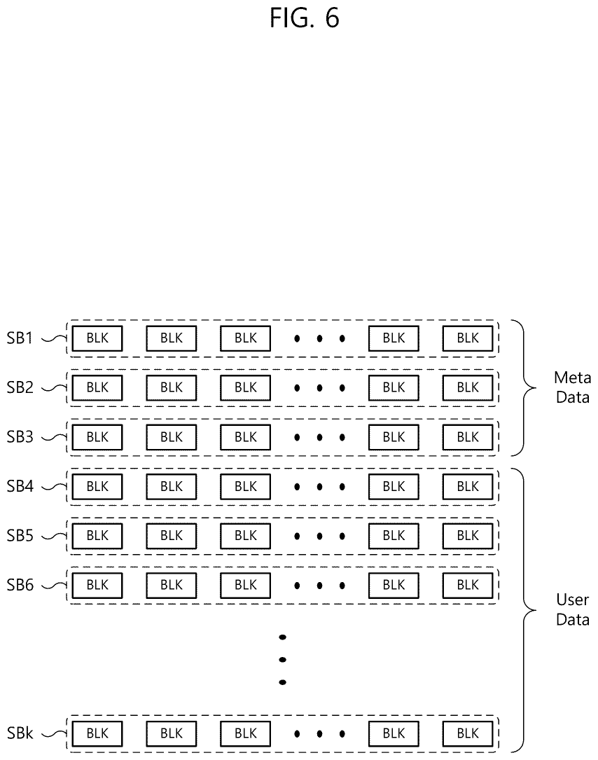

FIG. 6 is a diagram illustrating an example of matching a plurality of memory blocks included in the memory cell array of FIG. 2 with a plurality of super blocks according to some example embodiments. Referring to FIGS. 5 and 6, the super block managing module 1234 may match a plurality of memory blocks BLK to a plurality of super blocks SB1 to SBk. The FTL 1230 may manage data input or output between the memory device 1100 and the memory controller 1200 on a unit of super block.

According to some example embodiments, a portion of the plurality of super blocks SB1 to SBk may be used to store meta data and another portion of the plurality of super blocks SB1 to SBk may be used to store user data. For example, as illustrated in FIG. 6, the first to third super blocks SB1, SB2, and SB3 may be set to store the meta data. The fourth to kth super blocks SB4 to SBk may be set to store the user data. However, this is merely an example, and in some example embodiments at least one or more super blocks may be set to store the meta data.

According to some example embodiments, the meta data may include data necessary for management of the memory device 1100, excluding user data, such as data for address mapping, data for garbage collection, data for performing wear-leveling, etc. The meta data may be stored separately in each super block depending on its type. According to some example embodiments, some types of the meta data may occupy small capacity compared to capacity of one super block. Accordingly, super blocks allocated to the meta data (for example, the first to third super blocks SB1, SB2, and SB3) may include unused and wasted capacity.

According to some example embodiments, super blocks in which the user data are stored (for example, the fourth to k th super blocks SB4 to SBk) may include a user display space which is displayed to a user and an over-provisioning (OP) space used for enhancements of performance and lifespan of the memory device 1100. A size of super blocks where the user data is stored may be defined as the sum of a size of the user display space and a size of the OP space. The size of OP space may not be displayed to the user. However, in some example embodiments, when the number of bad blocks increases in the super blocks where the user data are stored, the size of the OP space may decrease, and then the performance and lifespan of the memory device 1100 may be affected.

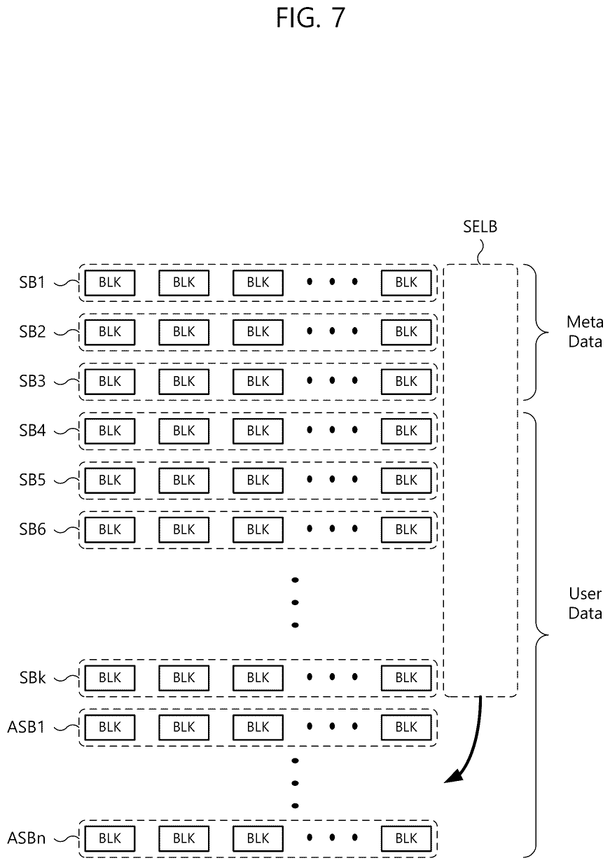

FIG. 7 is a diagram illustrating an example of a method for managing the super blocks of FIG. 6 according to some example embodiments. Referring to FIGS. 6 and 7, the super block managing module 1234 may increase the number of super blocks in which user data are stored by generating an additional super block.

According to some example embodiments, the super block managing module 1234 may select (or extract) a portion of memory blocks included in each of the plurality of super blocks SB1 to SBk (for example, selected memory blocks SELB). The super block managing module 1234 may generate additional super blocks by rearranging the selected memory blocks SELB. For example, the super block managing module 1234 may match using m selected memory blocks SELB into n additional super blocks ASB1 to ASBn. The FTL 1230 may allocate the additional super blocks ASB1 to ASBn as areas for storing the user data.

According to some example embodiments, the number of memory blocks included in each of the plurality of super blocks SB1 to SBk may be reduced. For example, the size of one super block may be reduced. Accordingly, the size of each super block in which the meta data are stored may be reduced. Waste of super blocks allocated depending on the type of meta data may be reduced. In some example embodiments, the number of super blocks in which the user data are stored may increase. Accordingly, the size of the OP space of the memory device 1100 may be increased.

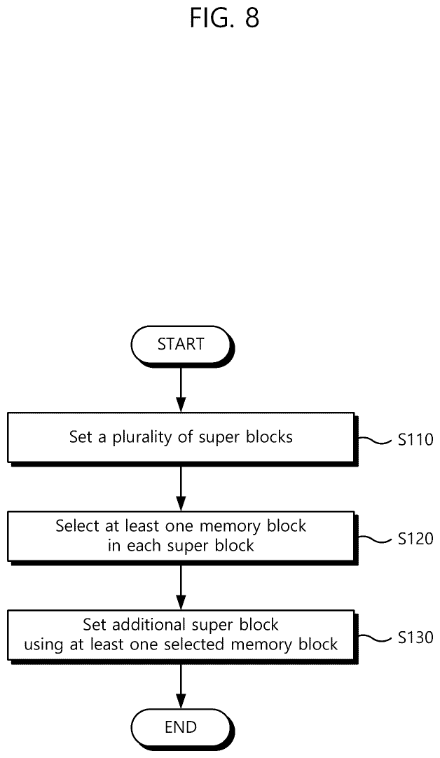

FIG. 8 is a flowchart illustrating the super block management method of FIG. 7 according to some example embodiments. Referring to FIGS. 6 to 8, the super block managing module 1234 may generate additional super blocks by rearranging selected memory blocks SELB.

According to some example embodiments, in operation S110, the memory controller 1200 may set a plurality of super blocks. For example, the memory device 1100 may include a plurality of memory blocks BLK. The super block managing module 1234 may match the plurality of memory blocks BLK to a plurality of super blocks SB1 to SBk. The super block managing module 1234 may match a specified number of memory blocks to each of the plurality of super blocks SB1 to SBk.

According to some example embodiments, in operation S120, the memory controller 1200 may select (or extract) at least one memory block from each super block. The memory controller 1200 may select (or extract) at least one memory block from each super block for a super block reallocation operation. The memory controller 1200 may format the storage device 1000 and perform the super block reallocation operation. For example, the super block managing module 1234 may select one or more memory blocks from each of the plurality of super blocks SB1 to SBk. In some example embodiments, in operation S120, the memory controller 1200 may select (or extract) at least one memory block from each super block, format the storage device 100 by releasing the matching of the plurality of memory blocks BLK to the plurality of super blocks SB1 to SBk (e.g., a matching of at least one selected memory block to corresponding super blocks may be undone), and perform the super block reallocation operation (e.g., reallocating/re-matching the at least one selected memory block to super blocks).

According to some example embodiments, in operation S130, the memory controller 1200 may set an additional super block using at least one memory block selected from each super block. For example, the super block managing module 1234 may rearrange the selected memory blocks SELB to generate additional super blocks ASB1 to ASBn. The FTL 1230 may allocate the additional super blocks ASB1 to ASBn as areas for storing user data.

As described above, the memory controller 1200 may generate the new additional super blocks ASB1 to ASBn based on the selected memory blocks SELB extracted from each of the plurality of super blocks SB1 to SBk set already. The additional super blocks ASB1 to ASBn may be allocated as an area to store the user data. Accordingly, the capacity of each of the plurality of existing super blocks SB1 to SBk may decrease, and the total number of super blocks may increase. Accordingly, the size of the OP space increases, and the performance and lifespan of the memory device 1100 may be improved.

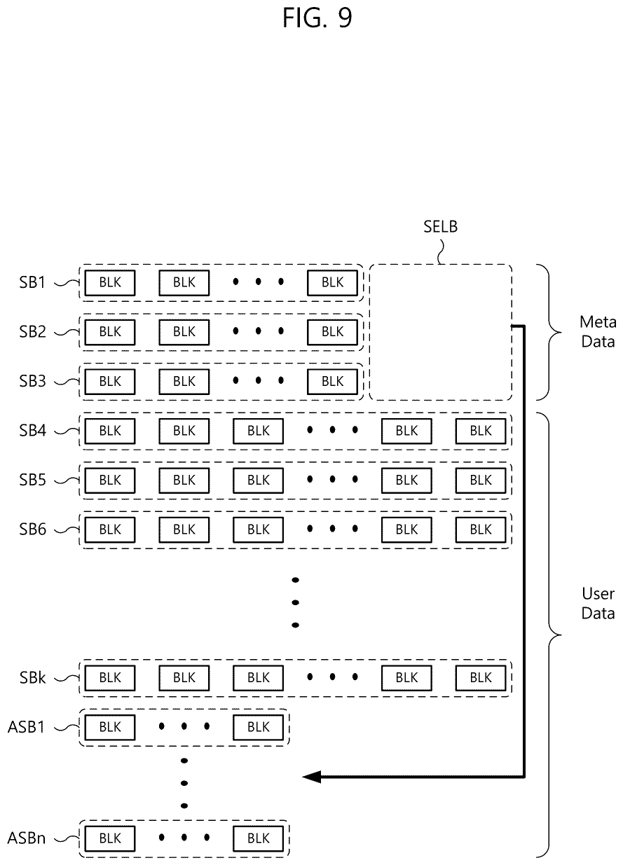

FIG. 9 is a diagram illustrating another example of a method for managing the super blocks of FIG. 6 according to some example embodiments. Referring to FIGS. 6 and 9, the super block managing module 1234 may increase the number of super blocks in which the user data are stored based on memory blocks of super blocks in which the meta data are stored.

According to some example embodiments, the super block managing module 1234 may select (or extract) a portion of memory blocks included in each of the super blocks in which the meta data are stored. As an example, the super block managing module 1234 may select a portion of memory blocks included in the first to third super blocks SB1, SB2, and SB3 as selected memory blocks SELB.

According to some example embodiments, the super block managing module 1234 may rearrange the selected memory blocks SELB to generate a new additional super block. For example, the super block managing module 1234 may match the selected memory blocks SELB into n additional super blocks ASB1 to ASBn.

According to some example embodiments, the number of memory blocks included in one of super blocks in which the meta data are stored (for example, the first to third super blocks SB1, SB2, and SB3), the number of memory blocks included in one of super blocks in which the user data are stored (for example, the fourth to k th super blocks SB4 to SBk) or the number of memory blocks included in one of the additional super blocks ASB1 to ASBn may be differently set each other. The FTL 1230 may allocate the additional super blocks ASB1 to ASBn as an area for storing the user data.

As described above, the number of memory blocks included in each of the super blocks in which the meta data are stored (for example, the first to third super blocks SB1, SB2, and SB3) may decrease. Accordingly, waste of super blocks allocated according to the type of meta data may be reduced. In some example embodiments, the number of super blocks in which the user data are stored may increase. Accordingly, the size of the OP space increases, and the performance and lifespan of the memory device 1100 may be improved.

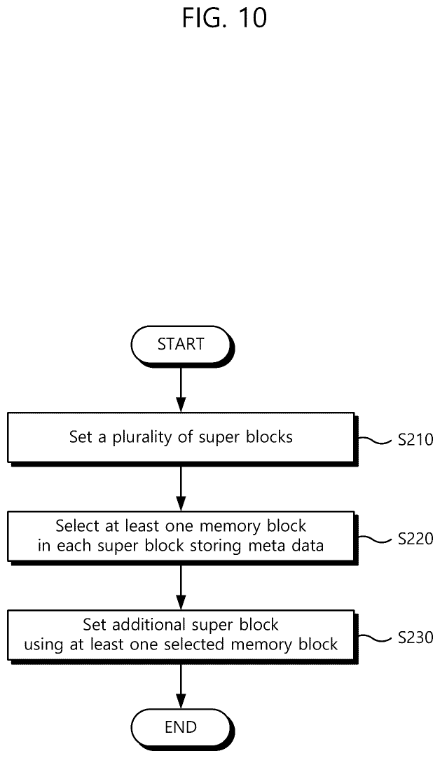

FIG. 10 is a flowchart illustrating the super block management method of FIG. 9 according to some example embodiments. Referring to FIGS. 6, 9, and 10, the super block managing module 1234 may generate additional super blocks by rearranging memory blocks of super blocks in which meta data are stored.

According to some example embodiments, in operation S210, the memory controller 1200 may set a plurality of super blocks. For example, the memory device 1100 may include a plurality of memory blocks BLK. The super block managing module 1234 may match the plurality of memory blocks BLK into a plurality of super blocks SB1 to SBk. The super block managing module 1234 may match a specified number of memory blocks to each of the plurality of super blocks SB1 to SBk.

According to some example embodiments, in operation S220, the memory controller 1200 may select (or extract) at least one memory block from each of the super blocks in which meta data are stored. The memory controller 1200 may select (or extract) at least one memory block from each of the super blocks in which the meta data are stored for a super block reallocation operation. The memory controller 1200 may format the storage device 1000 and perform the super block reallocation operation. For example, the super block managing module 1234 may select a portion of the memory blocks included in the first to third super blocks SB1, SB2, and SB3 as selected memory blocks SELB.

According to some example embodiments, in operation S230, the memory controller 1200 may set an additional super block using at least one memory block selected from each of the super blocks in which the meta data are stored. For example, the super block managing module 1234 may rearrange the selected memory blocks SELB to generate additional super blocks ASB1 to ASBn. The FTL 1230 may allocate the additional super blocks ASB1 to ASBn as an area for storing user data.

As described above, the number of memory blocks included in each of the super blocks in which the meta data are stored (for example, the first to third super blocks SB1, SB2, and SB3) may decrease. Accordingly, waste of super blocks allocated according to the type of meta data may be reduced. In some example embodiments, the number of super blocks in which the user data are stored may increase. Accordingly, the size of the OP space increases, and the performance and lifespan of the memory device 1100 may be improved.

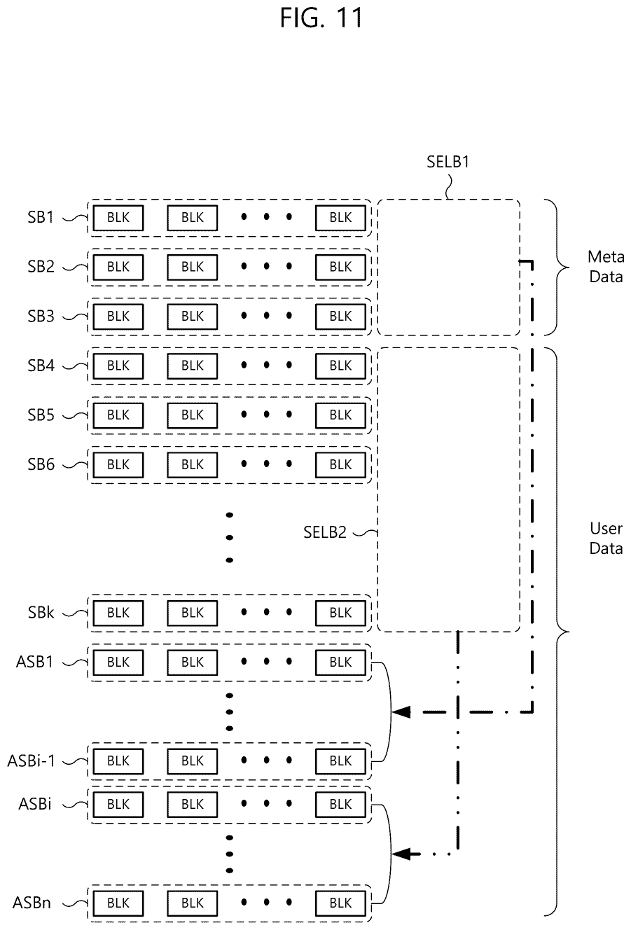

FIG. 11 is a diagram illustrating another example of a method for managing the super blocks of FIG. 6 according to some example embodiments. Referring to FIGS. 6 and 11, the super block managing module 1234 may generate additional super blocks to increase the number of super blocks in which user data are stored.

According to some example embodiments, the super block managing module 1234 may select (or extract) a portion of memory blocks included in each of the super blocks in which meta data are stored. For example, the super block managing module 1234 may select a portion of memory blocks included in the first to third super blocks SB1, SB2, and SB3 as a first selected memory block group SELB1.

According to some example embodiments, the super block managing module 1234 may select (or extract) a portion of memory blocks included in each of the super blocks in which the user data are stored. For example, the super block managing module 1234 may select a portion of the memory blocks included in the fourth to kth super blocks SB4 to SBk as a second selected memory block group SELB2.

According to some example embodiments, the super block managing module 1234 may rearrange the first selected memory block group SELB1 to generate a new first additional super block group. For example, the super block managing module 1234 may match the first selected memory block group SELB1 into the additional super blocks ASB1 to ASBi−1. The FTL 1230 may allocate the additional super blocks ASB1 to ASBi−1 as an area for storing the user data.

According to some example embodiments, the super block managing module 1234 may rearrange the second selected memory block group SELB2 to generate a new second additional super block group. For example, the super block managing module 1234 may match the second selected memory block group SELB2 into the additional super blocks ASBi to ASBn. The FTL 1230 may allocate the additional super blocks ASBi to ASBn as an area for storing user data.

For example, the number of memory blocks included in one of the super blocks in which the meta data are stored (for example, the first to third super blocks SB1, SB2, and SB3), the number of memory blocks included in one of the super blocks in which the user data are stored (for example, the fourth to k th super blocks SB4 to SBk) or the number of memory blocks included in one of the additional super blocks ASB1 to ASBn may be set to be equal to each other. In some example embodiments, the number of memory blocks included in one of the super blocks in which the meta data are stored (for example, the first to third super blocks SB1, SB2, and SB3), the number of memory blocks included in one of the super blocks in which the user data are stored (for example, the fourth to k th super blocks SB4 to SBk) or the number of memory blocks included in one of the additional super blocks ASB1 to ASBn may be set differently each other.

As described above, the number of memory blocks included in each of the super blocks in which the meta data are stored (for example, the first to third super blocks SB1, SB2, and SB3) may decrease. Accordingly, waste of super blocks allocated according to the type of meta data may be reduced. In some example embodiments, the number of super blocks in which the user data are stored may increase. Accordingly, the size of the OP space increases, and the performance and lifespan of the memory device 1100 may be improved.

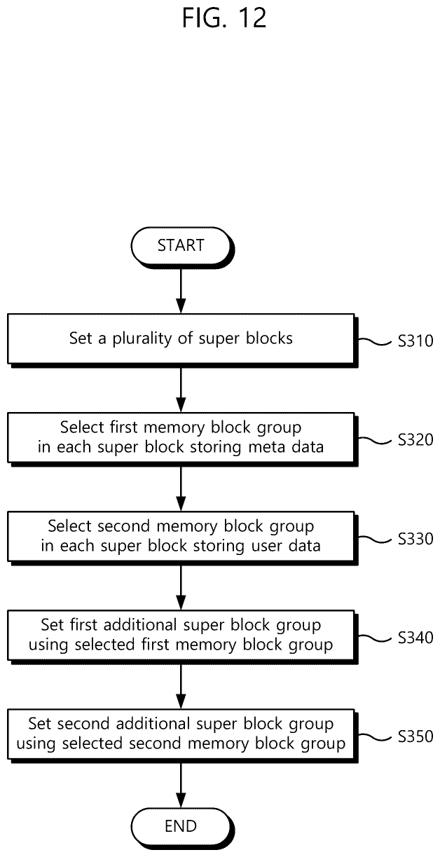

FIG. 12 is a flowchart illustrating the super block management method of FIG. 11 according to some example embodiments. Referring to FIGS. 6, 11, and 12, the super block managing module 1234 may rearrange a first selected memory block group SELB1 and a second selected memory block group SELB2 to generate a first additional super block group and a second selected memory block group.

According to some example embodiments, in operation S310, the memory controller 1200 may set a plurality of super blocks. For example, the memory device 1100 may include a plurality of memory blocks BLK. The super block managing module 1234 may match the plurality of memory blocks BLK into a plurality of super blocks SB1 to SBk. The super block managing module 1234 may match a specified number of memory blocks to each of the plurality of super blocks SB1 to SBk.

According to some example embodiments, in operation S320, the memory controller 1200 may select (or extract) at least one memory block from each of the super blocks in which meta data are stored. The memory controller 1200 may select (or extract) at least one memory block from each of the super blocks in which the meta data are stored for a super block reallocation operation. The memory controller 1200 may format the storage device 1000 and perform the super block reallocation operation. For example, the super block managing module 1234 may select a portion of the memory blocks included in the first to third super blocks SB1, SB2, and SB3 as the first selected memory block group SELB1.

According to some example embodiments, in operation S330, the memory controller 1200 may select (or extract) at least one memory block from each of the super blocks in which user data are stored. The memory controller 1200 may select (or extract) at least one memory block from each of the super blocks in which the user data are stored for a super block reallocation operation. For example, the super block managing module 1234 may select a portion of the memory blocks included in the fourth to kth super blocks SB4 to SBk as the second selected memory block group SELB2. During formatting the storage device 1000, the super block managing module 1234 may select the first selected memory block group SELB1 or the second selected memory block group SELB2.

According to some example embodiments, in operation S340, the memory controller 1200 may set a first additional super block group using the first selected memory block group SELB1. For example, the super block managing module 1234 may rearrange the first selected memory block group SELB1 to generate additional super blocks ASB1 to ASBi−1. The FTL 1230 may allocate the additional super blocks ASB1 to ASBi−1 as an area for storing the user data.

According to some example embodiments, in operation S350, the memory controller 1200 may set a second additional super block group using the second selected memory block group SELB2. For example, the super block managing module 1234 may rearrange the second selected memory block group SELB2 to generate additional super blocks ASBi to ASBn. The FTL 1230 may allocate the additional super blocks ASBi to ASBn as an area for storing the user data.

As described above, the number of memory blocks included in each of the super blocks in which the meta data are stored (for example, the first to third super blocks SB1, SB2, and SB3) may decrease. Accordingly, waste of super blocks allocated according to the type of meta data may be reduced. In some example embodiments, the number of super blocks in which the user data are stored may increase. Accordingly, the size of the OP space may increase, and the performance and lifespan of the memory device 1100 may be improved.

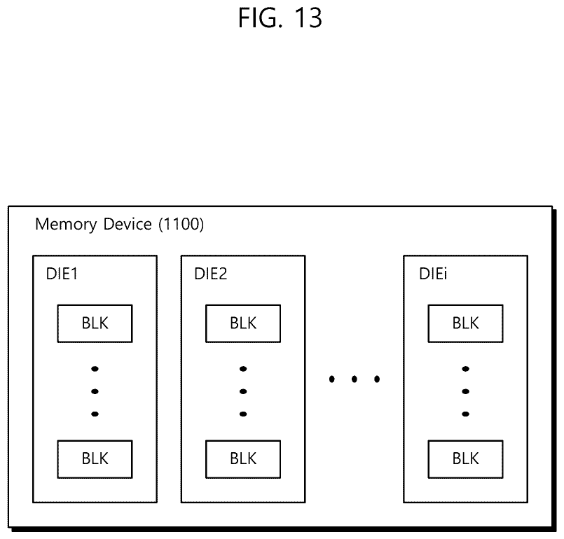

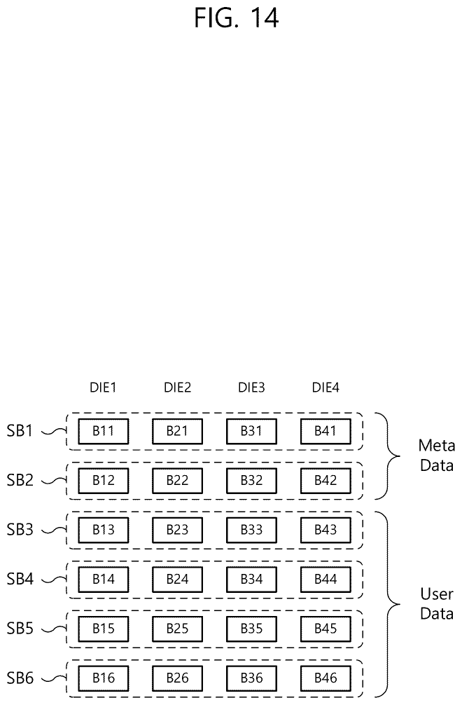

FIG. 13 is a diagram illustrating another example of the memory device of FIG. 1 according to some example embodiments. FIG. 14 is a diagram illustrating a plurality of super blocks set in the memory device of FIG. 13 according to some example embodiments. Referring to FIGS. 13 and 14, the memory device 1100 may include a plurality of memory dies DIE1 to DIEi. Each of the plurality of memory dies DIE1 to DIEi may include a plurality of memory blocks BLK. A plurality of super blocks SB1 to SB6 may be set across a plurality of memory dies DIE1 to DIEi. Although FIG. 14 illustrates four memory dies and six super blocks, in some example embodiments, the number of memory dies included in the memory device 1100 and the number of super blocks set in the memory device 1100 are not limited thereto.

According to some example embodiments, each of the plurality of memory dies DIE1 to DIEi may operate according to configurations of the memory device 1100 of FIG. 2. The plurality of memory dies DIE1 to DIEi may be divided into a plurality of groups and exchange data with the memory controller 1200 of FIG. 1 through a plurality of channels. The plurality of memory dies DIE1 to DIEi may exchange data with the memory controller 1200 by an interleaving manner through a plurality of channels.

According to some example embodiments, each of the plurality of memory dies DIE1 to DIEi may include a plurality of memory blocks. For example, the first memory die DIE1 may include first memory blocks B11, B12, B13, B14, B15 and B16. The second memory die DIE2 may include second memory blocks B21, B22, B23, B24, B25 and B26. The third memory die DIE3 may include third memory blocks B31, B32, B33, B34, B35 and B36. The fourth memory die DIE4 may include fourth memory blocks B41, B42, B43, B44, B45 and B46.

According to some example embodiments, the super block managing module 1234 may set one super block by selecting one memory block from each of the plurality of memory dies DIE1 to DIEi. As an example, the first super block SB1 may include memory blocks B11, B21, B31 and B41. The second super block SB2 may include memory blocks B12, B22, B32 and B42. The third super block SB3 may include memory blocks B13, B23, B33 and B43. The fourth super block SB4 may include memory blocks B14, B24, B34 and B44. The fifth super block SB5 may include memory blocks B15, B25, B35 and B45. The sixth super block SB6 may include memory blocks B16, B26, B36 and B46.

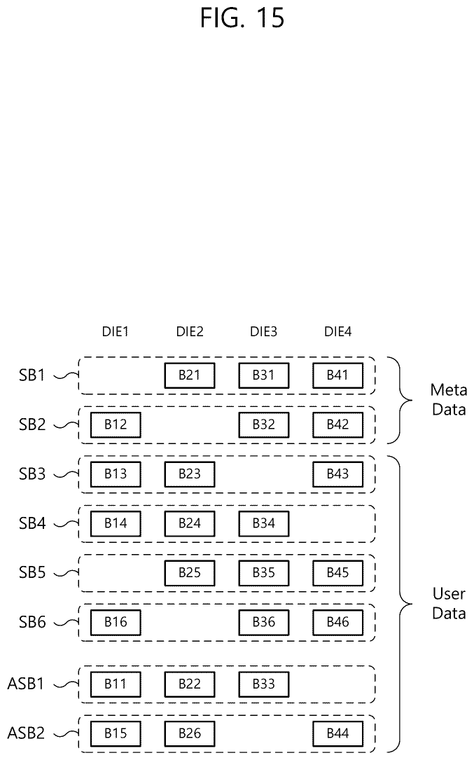

According to some example embodiments, the first super block SB1 and the second super block SB2 may store meta data. The third to sixth super blocks SB3 to SB6 may store user data. FIGS. 15 to 21 are explained based on setting of the super block of FIG. 14. However, this is merely an example for convenience of explanation, and example embodiments are not limited thereto. The memory device 1100 may include at least one memory die, and memory blocks included in the memory device 1100 may be matched into a plurality of super blocks.

FIG. 15 is a diagram illustrating an example of a method for managing the super blocks of FIG. 14 according to some example embodiments. Referring to FIGS. 14 and 15, the super block managing module 1234 may generate an additional super block by selecting at least one memory block from each of the plurality of super blocks SB1 to SB6.

According to some example embodiments, the super block managing module 1234 may select at least one memory block from each super block (for example, the first and second super blocks SB1 and SB2) which stores meta data. For example, the super block managing module 1234 may select the 11th memory block B11 from the first super block SB1. The super block managing module 1234 may select the 22nd memory block B22 from the second super block SB2.

According to some example embodiments, the super block managing module 1234 may select at least one memory block from each super block (for example, the third to sixth super blocks SB3 to SB6) which stores user data. For example, the super block managing module 1234 may select the 33rd memory block B33 from the third super block SB3. The super block managing module 1234 may select the 44th memory block B44 from the fourth super block SB4. The super block managing module 1234 may select the 15th memory block B15 from the fifth super block SB5. The super block managing module 1234 may select the 26th memory block B26 from the sixth super block SB6.

According to some example embodiments, the super block managing module 1234 may select memory blocks from each super block such that the selected memory blocks may be evenly distributed across a plurality of memory dies DIE1 to DIE4. For example, when selecting a memory block from a super block, the super block managing module 1234 may select a next memory block from a memory die which the number of selected memory blocks is the smallest.

According to some example embodiments, the super block managing module 1234 may generate an additional super block based on selected memory blocks B11, B22, B33, B44, B15 and B26. For example, the super block managing module 1234 may generate a first additional super block ASB1 and a second additional super block ASB2. For example, the super block managing module 1234 may match the 11th memory block B11, the 22nd memory block B22 and the 33rd memory block B33 to the first additional super block ASB1. The super block managing module 1234 may match the 15th memory block B15, the 26th memory block B26 and the 44th memory block B44 to the second additional super block ASB2.

According to some example embodiments, after generating an additional super block, the super block managing module 1234 may set the number of memory blocks (for example, three) included in each of the existing super blocks SB1 to SB6 and the number of memory blocks included in each of the new additional super blocks ASB1 and ASB2 to be the same. New generated additional super blocks (for example, the first additional super block ASB1 and the second additional super block ASB2) may be set to store the user data.

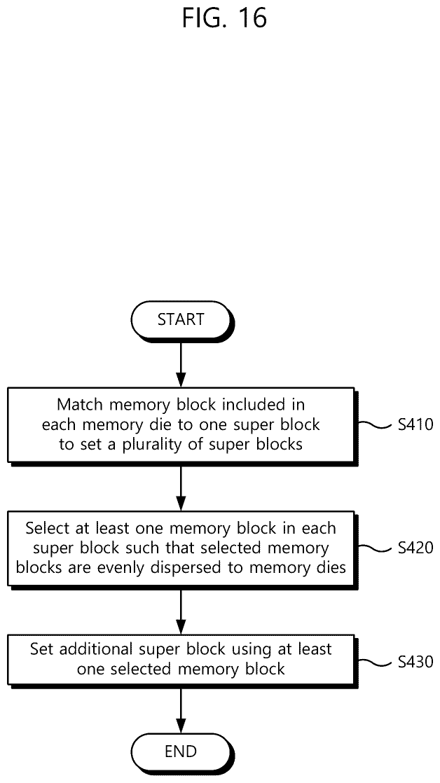

FIG. 16 is a flowchart illustrating the super block management method of FIG. 15 according to some example embodiments. Referring to FIGS. 14 to 16, the super block managing module 1234 may rearrange memory blocks selected from each of a plurality of super blocks to generate at least one additional super block.

According to some example embodiments, in operation S410, the memory controller 1200 may set a plurality of super blocks by matching memory blocks included in each memory die to one super block. For example, the memory device 1100 may include a plurality of memory dies DIE1 to DIE4. Each of the plurality of memory dies DIE1 to DIE4 may include a plurality of memory blocks.

For example, a first super block SB1 may include memory blocks B11, B21, B31 and B41. A second super block SB2 may include memory blocks B12, B22, B32 and B42. A third super block SB3 may include memory blocks B13, B23, B33 and B43. A fourth super block SB4 may include memory blocks B14, B24, B34 and B44. A fifth super block SB5 may include memory blocks B15, B25, B35 and B45. A sixth super block SB6 may include memory blocks B16, B26, B36 and B46.

For example, the first super block SB1 and the second super block SB2 may store meta data. The third to sixth super blocks SB3 to SB6 may store user data.

According to some example embodiments, in operation S420, the memory controller 1200 may select (or extract) at least one memory block from each super block such that selected memory blocks may be evenly distributed across the memory dies. For example, the super block managing module 1234 may select at least one memory block from each super block (for example, the first and second super blocks SB1 and SB2) which stores the meta data. The super block managing module 1234 may select at least one memory block from each super block (for example, the third to sixth super blocks SB3 to SB6) which stores the user data.

For example, the super block managing module 1234 may select the 11th memory block B11 from the first super block SB1. The super block managing module 1234 may select the 22nd memory block B22 from the second super block SB2. The super block managing module 1234 may select the 33rd memory block B33 from the third super block SB3. The super block managing module 1234 may select the 44th memory block B44 from the fourth super block SB4. The super block managing module 1234 may select the 15th memory block B15 from the fifth super block SB5. The super block managing module 1234 may select the 26th memory block B26 from the sixth super block SB6.

According to some example embodiments, in operation S430, the memory controller 1200 may set an additional super block using at least one selected memory block. For example, the super block managing module 1234 may determine the number of additional super blocks based on the number of selected memory blocks.

For example, the super block managing module 1234 may match the 11th memory block B11, the 22nd memory block B22, and the 33rd memory block B33 to a first additional super block ASB1. The super block managing module 1234 may match the 15th memory block B15, the 26th memory block B26, and the 44th memory block B44 to a second additional super block ASB2.

According to some example embodiments, after generating an additional super block, the super block managing module 1234 may determine the number of memory blocks included in each of the existing super blocks SB1 to SB6 (for example, three) and the number of memory blocks included in each of the new additional super blocks ASB1 and ASB2 may be set to be the same. Newly generated additional super blocks (for example, the first additional super block ASB1 and the second additional super block ASB2) may be set to store the user data. The FTL 1230 may allocate the additional super blocks (for example, the first additional super block ASB1 and the second additional super block ASB2) as an area for storing the user data.

As described above, the number of memory blocks included in each of the super blocks in which the meta data are stored (for example, the first and second super blocks SB1 and SB2) may decrease. Accordingly, waste of super blocks allocated according to the type of meta data may be reduced. In some example embodiments, the number of super blocks in which user data are stored may increase. Accordingly, the size of the OP space increases, and the performance and lifespan of the memory device 1100 may be improved.

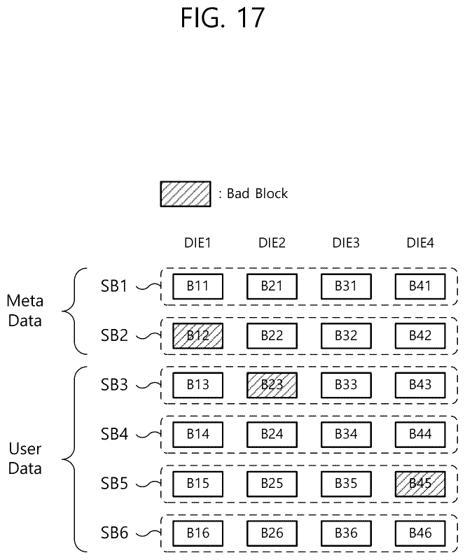

FIG. 17 is a diagram illustrating a plurality of super blocks set in the memory device of FIG. 13 according to some example embodiments. Referring to FIGS. 13 and 17, the memory device 1100 may include a plurality of memory dies DIE to DIEi. Each of the plurality of memory dies DIE1 to DIEi may include a plurality of memory blocks BLK. A plurality of super blocks SB1 to SB6 may be set across the plurality of memory dies DIE1 to DIEi. Although FIG. 17 illustrates four memory dies and six super blocks, the number of memory dies included in the memory device 1100 and the number of super blocks set in the memory device 1100 are not limited thereto. The characteristics of the plurality of memory dies and the plurality of super blocks of FIG. 17 may be the same as the characteristics of the plurality of memory dies and the plurality of super blocks of FIG. 14. Accordingly, description of the same features as the plurality of memory dies and the plurality of super blocks in FIG. 14 will be omitted.

According to some example embodiments, a portion of the plurality of super blocks may include bad blocks. For example, the 12th memory block B12 included in the second super block SB2 may be detected as a bad block. The 23rd memory block B23 included in the third super block SB3 may be detected as a bad block. The 45th memory block B45 included in the fifth super block SB5 may be detected as a bad block. The FTL 1230 may disconnect memory blocks detected as bad blocks from the super blocks.

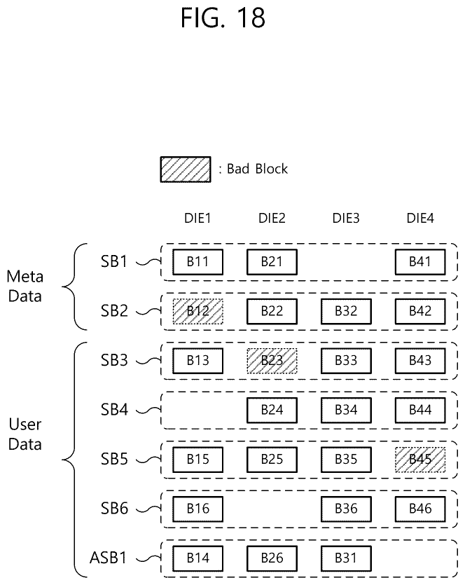

FIG. 18 is a diagram illustrating an example of a method for managing the super blocks of FIG. 17 according to some example embodiments. Referring to FIGS. 17 and 18, the super block managing module 1234 may generate an additional super block by selecting at least one memory block from each of the plurality of super blocks SB1 to SB6.

According to some example embodiments, the super block managing module 1234 may perform a super block reallocation operation during formatting the storage device 1000. During the super block reallocation operation, a super block including a bad block may be configured as a first partial super block excluding the bad block. During the super block reallocation operation, a super block which does not include a bad block may be configured as a second partial super block by excluding at least one memory block.

For example, the super block managing module 1234 may configure the number of memory blocks included in the first partial super block to be the same as the number of memory blocks included in the second partial super block. The super block managing module 1234 may configure the number of memory blocks included in a new additional super block to be the same as the number of memory blocks included in the first partial super block and/or the second partial super block. In some example embodiments, the super block managing module 1234 may configure the number of memory blocks included in the first partial super block, the second partial super block, or the additional super block to be different each other.

According to some example embodiments, the super block managing module 1234 may select a super block which does not include a bad block. For example, the super block managing module 1234 may select the first super block SB1, the fourth super block SB4 and the sixth super block SB6.

According to some example embodiments, the super block managing module 1234 may select at least one memory block from among the selected super blocks. For example, the super block managing module 1234 may select a memory block on a memory die which does not include a bad block. For example, the super block managing module 1234 may select the 31st memory block B31 from the first super block SB1 and the third die DIE3. According to some example embodiments, when there are no more memory dies with bad blocks, the super block managing module 1234 may select a memory block by sequentially rotating through the remaining memory dies. For example, the super block managing module 1234 may select the 14th memory block B14 from the fourth super block SB4 and the first die DIE1. The super block managing module 1234 may select the 26th memory block B26 from the sixth super block SB6 and the second die DIE2.

According to some example embodiments, the super block managing module 1234 may generate at least one additional super block based on selected memory blocks. For example, the super block managing module 1234 may match the 31st memory block B31, the 14th memory block B14, and the 26th memory block B26 to a first additional super block ASB1.

As described above, the number of memory blocks included in a super block in which the meta data are stored (for example, the first super block SB1) may decrease. Accordingly, waste of super blocks allocated according to the type of meta data may be reduced. In some example embodiments, the number of super blocks in which the user data are stored may increase. Accordingly, the size of the OP space increases, and the performance and lifespan of the memory device 1100 may be improved. In some example embodiments, considering bad blocks, the number of memory blocks included in each super block may be evenly distributed.

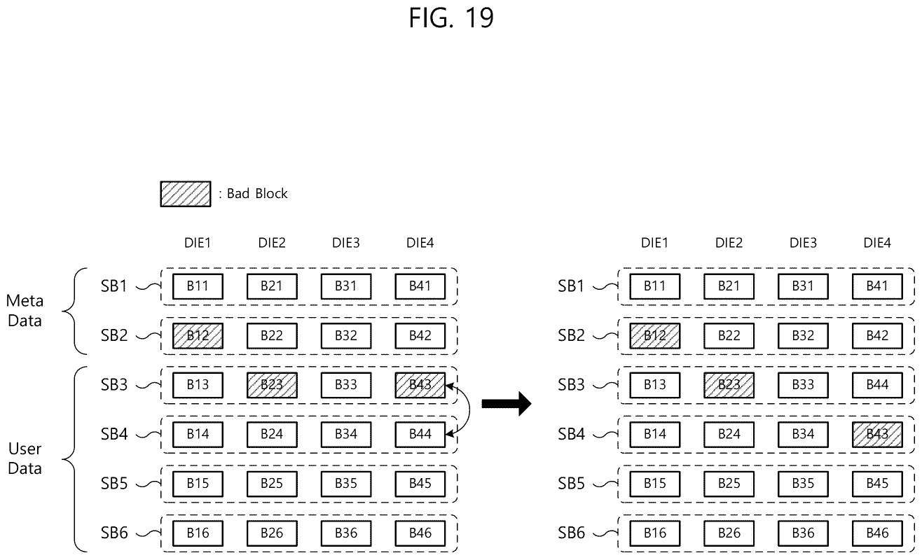

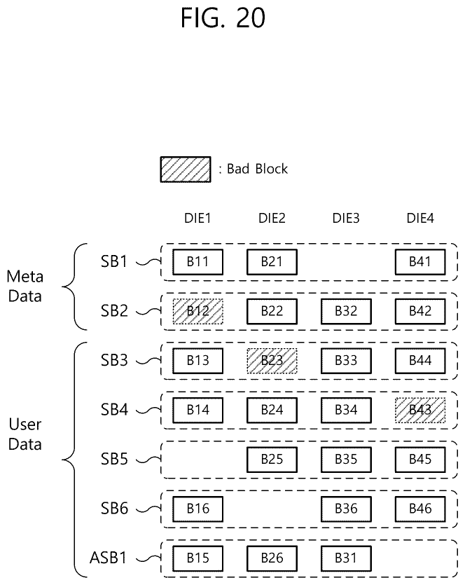

FIG. 19 is a diagram illustrating a plurality of super blocks set in the memory device of FIG. 13 according to some example embodiments. FIG. 20 is a diagram illustrating an example of a method for managing the super blocks of FIG. 19 according to some example embodiments. Referring to FIGS. 13, 19, and 20, the memory device 1100 may include a plurality of memory dies DIE1 to DIEi. Each of the plurality of memory dies DIE1 to DIEi may include a plurality of memory blocks BLK. A plurality of super blocks SB1 to SB6 may be set across a plurality of memory dies DIE1 to DIEi. Although FIG. 19 illustrates four memory dies and six super blocks, the number of memory dies included in the memory device 1100 and the number of super blocks set in the memory device 1100 are not limited thereto. The characteristics of the plurality of memory dies and the plurality of super blocks of FIGS. 19 and 20 may be the same as the characteristics of the plurality of memory dies and the plurality of super blocks of FIG. 14. Accordingly, description of the same features as the plurality of memory dies and the plurality of super blocks in FIG. 14 will be omitted.

According to some example embodiments, the super block managing module 1234 may perform a super block reallocation operation during formatting the storage device 1000. For example, during the super block reallocation operation, a super block including a bad block may be configured as a first partial super block excluding the bad block. For example, during the super block reallocation operation, a super block which does not include a bad block may be configured as a second partial super block by excluding at least one memory block. For example, the super block managing module 1234 may configure the number of memory blocks included in the first partial super block to be the same as the number of memory blocks included in the second partial super block. The super block managing module 1234 may configure the number of memory blocks included in a new additional super block to be the same as the number of memory blocks included in the first partial super block and/or the second partial super block. In some example embodiments, the super block managing module 1234 may configure the number of memory blocks included in the first partial super block, the second partial super block, or the additional super block to be different each other.

According to some example embodiments, a portion of the plurality of super blocks may include bad blocks. In some example embodiments, at least one super block may include multiple bad blocks. For example, the 12th memory block B12 included in the second super block SB2 may be detected as a bad block. The 23rd memory block B23 and the 43rd memory block B43 included in the third super block SB3 may be detected as bad blocks. The FTL 1230 may disconnect memory blocks detected as bad blocks from the super block.

According to some example embodiments, the super block managing module 1234 may change matching of bad blocks to minimize the number of bad blocks included in each super block. For example, the super block managing module 1234 may replace matching of the 43rd memory block B43 and the 44th memory block B44. The super block managing module 1234 may match the 43rd memory block B43 to the fourth super block SB4 and match the 44th memory block B44 to the third super block SB3.

According to some example embodiments, after distributing bad blocks evenly to super blocks, the super block managing module 1234 may generate at least one additional super block in the same manner as illustrated in FIG. 18. As an example, the super block managing module 1234 may select the 31st memory block B31, the 15th memory block B15 and the 26th memory block B26. The super block managing module 1234 may match the selected 31st memory block B31, 15th memory block B15 and 26th memory block B26 to a first additional super block ASB1.

As described above, the number of memory blocks included in a super block in which the meta data are stored (for example, the first super block SB1) may decrease. Accordingly, waste of super blocks allocated according to the type of meta data may be reduced. In some example embodiments, the number of super blocks in which the user data are stored may increase. Accordingly, the size of the OP space increases, and the performance and lifespan of the memory device 1100 may be improved. In some example embodiments, considering bad blocks, the number of memory blocks included in each super block may be evenly distributed.

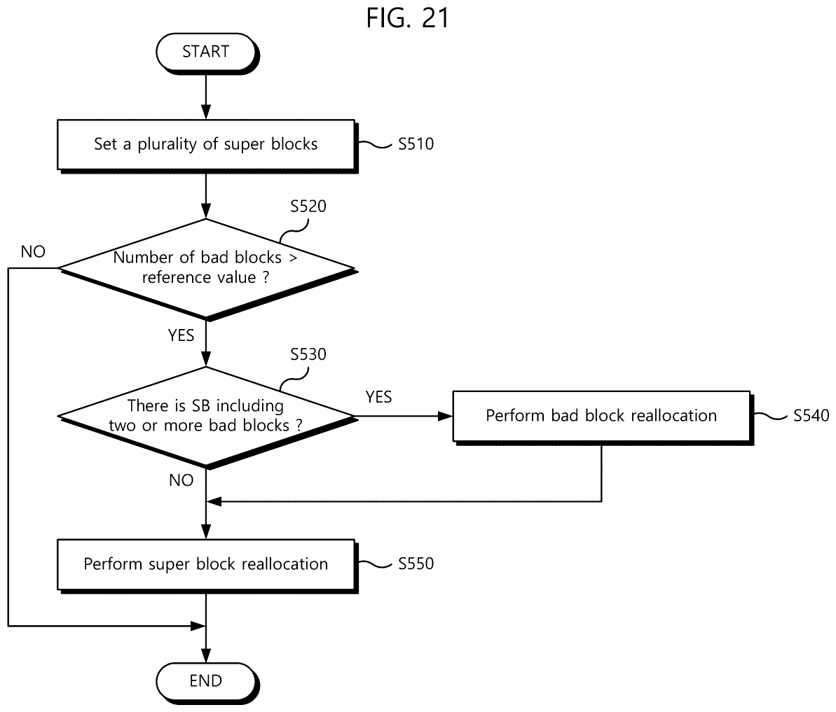

FIG. 21 is a flowchart illustrating the super block management method of FIGS. 17 to 20 according to some example embodiments. Referring to FIGS. 17 to 21, the super block managing module 1234 may rearrange memory blocks selected from each of a plurality of super blocks to generate at least one additional super block.

According to some example embodiments, in operation S510, the memory controller 1200 may set a plurality of super blocks by matching memory blocks included in each memory die to one super block. For example, the memory device 1100 may include a plurality of memory dies DIE1 to DIE4. Each of the plurality of memory dies DIE1 to DIE4 may include a plurality of memory blocks.

For example, a first super block SB1 may include memory blocks B11, B21, B31 and B41. A second super block SB2 may include memory blocks B12, B22, B32 and B42. A third super block SB3 may include memory blocks B13, B23, B33 and B43. A fourth super block SB4 may include memory blocks B14, B24, B34 and B44. A fifth super block SB5 may include memory blocks B15, B25, B35 and B45. A sixth super block SB6 may include memory blocks B16, B26, B36 and B46. The first super block SB1 and the second super block SB2 may store meta data. The third to sixth super blocks SB3 to SB6 may store user data.

According to some example embodiments, in operation S520, the memory controller 1200 may check the number of bad blocks among all memory blocks. When the number of bad blocks is less than or equal to a specified reference value, the memory controller 1200 may maintain the existing super block without performing a super block reallocation operation. When the number of bad blocks is greater than the specified reference value, the memory controller 1200 may perform the super block reallocation operation through operations S530 to S550. The memory controller 1200 may format the storage device 1000 and perform the super block reallocation operation. For example, when the number of bad blocks is greater than the specified reference value (for example, two), the super block managing module 1234 may perform the super block reallocation operation of FIG. 18 or FIG. 20.

According to some example embodiments, in operation S530, the memory controller 1200 may check the number of bad blocks included in each super block (SB). When a super blocks (SBs) including two or more bad blocks exists, the memory controller 1200 may perform operation S540. When there is no super block containing two or more bad blocks (or when each super block contains one or no bad block), the memory controller 1200 may perform operation S550.

According to some example embodiments, in operation S540, the memory controller 1200 may perform a bad block reallocation operation. For example, when a super block including two or more bad blocks exists, the super block managing module 1234 may perform the bad block reallocation operation. The super block managing module 1234 may change matching of bad blocks to minimize the number of bad blocks included in each super block.

For example, in FIG. 19, the super block managing module 1234 may include the third super block SB3 including two bad blocks (for example, the 23rd memory block B23 and the 43rd memory block B43). The super block managing module 1234 may replace matching of the 43rd memory block B43 and the 44th memory block B44. The super block managing module 1234 may match the 43rd memory block B43 to the fourth super block SB4 and match the 44th memory block B44 to the third super block SB3.

According to some example embodiments, in operation S550, the memory controller 1200 may perform a super block reallocation operation. For example, the super block managing module 1234 may select a super block which does not include bad blocks. The super block managing module 1234 may select at least one memory block from among the selected super blocks. The super block managing module 1234 may generate at least one additional super block based on the selected memory blocks.

For example, when there is no super block containing two or more bad blocks (or when each super block contains one or no bad block), the super block managing module 1234 may immediately perform the super block reallocation operation. Referring to FIGS. 17 and 18, the super block managing module 1234 may select the 31st memory block B31, the 14th memory block B14 and the 26th memory block B26. The super block managing module 1234 may match the 31st memory block B31, the 14th memory block B14 and the 26th memory block B26 to a first additional super block ASB1.

According to some example embodiments, when a super block including two or more bad blocks exists, the super block managing module 1234 may generate an additional super block after the bad blocks are evenly distributed among the super blocks in operation S540. Referring to FIGS. 19 and 20, the super block managing module 1234 may select the 31st memory block B31, the 15th memory block B15 and the 26th memory block B26. The super block managing module 1234 may match the 31st memory block B31, 15th memory block B15 and 26th memory block B26 to a first additional super block ASB1.

Accordingly, in some example embodiments, it may be possible to reduce the number of wasted memory blocks and increase capacity of super blocks which stores the user data.

As described herein, any devices, electronic devices, modules, units, and/or portions thereof according to any of the example embodiments, and/or any portions thereof may include, may be included in, and/or may be implemented by one or more instances of processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a solid state drive (SSD), storing a program of instructions, and a processor (e.g., CPU) configured to execute the program of instructions to implement the functionality and/or methods performed by some or all of any devices, electronic devices, modules, units, and/or portions thereof according to any of the example embodiments.

Any of the memories described herein may be a non-transitory computer readable medium and may store a program of instructions. Any of the memories described herein may be a nonvolatile memory, such as a flash memory, a phase-change random access memory (PRAM), a magneto-resistive RAM (MRAM), a resistive RAM (ReRAM), or a ferro-electric RAM (FRAM), or a volatile memory, such as a static RAM (SRAM), a dynamic RAM (DRAM), or a synchronous DRAM (SDRAM).

While the present inventive concepts have been described with reference to example embodiments thereof, it will be apparent to those of ordinary skill in the art that various changes and modifications may be made thereto without departing from the spirit and scope of the present inventive concepts as set forth in the following claims.

What is claimed is:

1. A storage device, comprising:
a memory device including a plurality of memory blocks; and
a memory controller configured to match the plurality of memory blocks to a plurality of super blocks in numbers of memory blocks,
wherein the memory controller is further configured to:
select at least one memory block from each of super blocks that contain no bad blocks among the plurality of super blocks,
release the matching of the at least one selected memory block from each of the super blocks that contain no bad blocks, and
generate at least one additional super block based on the at least one selected memory block.

2. The storage device of claim 1, wherein the memory controller is configured to store meta data in first super blocks among the plurality of super blocks and store user data in second super blocks among the plurality of super blocks.

3. The storage device of claim 2, wherein the memory controller is configured to select at least one memory block from each of the first super blocks to match the at least one selected memory block to a first additional super block.

4. The storage device of claim 2, wherein the memory controller is configured to select at least one memory block from each of the second super blocks to match the at least one selected memory block to a second additional super block.

5. The storage device of claim 1, wherein the memory controller is configured to, in response to a determination that a super block contains multiple bad blocks:
relocate the multiple bad blocks to the plurality of super blocks such that a number of bad blocks included in one super block is minimized, and
set the at least one selected memory block among the super blocks that contain no bad blocks.

6. The storage device of claim 1, wherein the memory controller is configured to match the at least one selected memory block to the at least one additional super block after generating the at least one additional super block such that a number of memory blocks included in each of the plurality of super blocks is equal to a number of memory blocks included in the at least one additional super block.

7. A storage device, comprising:
a memory device including a plurality of memory dies; and
a memory controller configured to match at least one memory block included in each of the plurality of memory dies to each of a plurality of super blocks,
the memory controller further configured to:
store meta data in first super blocks among the plurality of super blocks,
store user data in second super blocks among the plurality of super blocks,
select first memory blocks from each of the first super blocks,
release matching of the first memory blocks from each of the first super blocks,
select second memory blocks from each of the second super blocks,
release matching of the second memory blocks from each of the second super blocks, and
generate at least one additional super block based on the first memory blocks and the second memory blocks.

8. The storage device of claim 7, wherein the memory controller is configured to select the first memory blocks and the second memory blocks to be evenly distributed across the plurality of memory dies.

9. The storage device of claim 7, wherein the memory controller is configured to set a number of memory blocks included in the at least one additional super block same as a number of memory blocks ultimately included in each of the plurality of super blocks.

10. The storage device of claim 7, wherein the memory controller is configured to set a number of memory blocks included in the at least one additional super block different from a number of memory blocks ultimately included in each of the plurality of super blocks.

11. The storage device of claim 7, wherein the memory controller is configured to select the first memory blocks and the second memory blocks by sequentially rotating through the plurality of super blocks.

12. The storage device of claim 11, wherein, after a memory block is selected from a first memory die of one super block, the memory controller is configured to select a memory block from a second memory die of another super block excluding the first memory die.

13. The storage device of claim 7, wherein the memory controller is configured to set the first memory blocks and the second memory blocks in each of remaining super blocks excluding super blocks that include bad blocks among the plurality of super blocks.

14. The storage device of claim 7, wherein the memory controller is configured to, in response to a determination that a super block contains multiple bad blocks:
relocate the multiple bad blocks to the plurality of super blocks such that a number of bad blocks included in one super block is minimized, and
set the first memory blocks and the second memory blocks among super blocks that include no bad blocks.

15. A super block managing method of a storage device including a plurality of memory blocks, the method comprising:
setting a plurality of super blocks by matching a plurality of memory blocks in numbers of memory blocks;
selecting at least one memory block from each of the plurality of super blocks; and
generating at least one additional super block based on the selected memory blocks.

16. The method of claim 15, wherein first super blocks among the plurality of super blocks are configured to store meta data, and second super blocks among the plurality of super blocks are configured to store user data.

17. The method of claim 16, wherein first memory blocks selected from each of the first super blocks are matched to a first additional super block.

18. The method of claim 16, wherein second memory blocks selected from each of the second super blocks are matched to a second additional super block.

19. The method of claim 15, wherein the selecting of the at least one memory block includes setting the selected memory blocks in each of remaining super blocks excluding super blocks that contain bad blocks among the plurality of super blocks.

20. The method of claim 15, wherein
the selecting of the at least one memory block includes:
in response to a determination that a super block contains multiple bad blocks,
relocating the multiple bad blocks to the plurality of super blocks such that a number of bad blocks included in one super block is minimized,
setting the selected memory blocks among super blocks that include no bad blocks.
